(19) United States
(12) Patent Application Publication
(10) Pub. No.: US 2026/0037898 A1
(43) Pub. Date: Feb. 5, 2026

(54) DEPTH CHART VISUALIZATION FOR TEAM MANAGEMENT

(71) Applicant: SumerSports, LLC., Palm Beach, FL (US)

(72) Inventors: Lorrissa Jane Horton, Seattle, WA (US); Jonathan Recil Lucero, Sammamish, WA (US); Jonathan M. Luk, Seattle, WA (US); John Paul Jones, II, West Palm Beach, FL (US); Sree Krishna Vadde, New Canaan, CT (US); Steven Santiago, New Canaan, CT (US); Jonathan Charles Asnon, Santa Monica, CA (US); Eric Edmund Iannaccone, Ramsey, NJ (US); Lucia Elizabeth Kent, Oak Park, IL (US); William Thomas Tejeda, Princeton, MA (US)

(21) Appl. No.: 19/286,449

(22) Filed: Jul. 31, 2025

Related U.S. Application Data
(60) Provisional application No. 63/678,771, filed on Aug. 2, 2024.

(51) Int. Cl. G06Q 10/0637

(52) U.S. Cl. CPC G06Q 10/0637

(57) ABSTRACT

In one embodiment, techniques relate to a method including rendering a depth chart for a team for viewing on a display screen of a system, the team including personnel, the depth chart including at least one card, the at least one card include at least one parameter associated with the personnel, wherein the system enables a user to manipulate the depth chart. The method also includes identifying a manipulation of the depth chart, determining whether data used to render the depth chart has been updated, and updating the depth chart based on the manipulation, wherein when it is determined that the data has been updated, updating the depth chart further includes updating the depth chart based on the data that has been updated, and wherein updating the depth chart creates an updated depth chart. The method further includes rendering the updated depth chart for viewing on the display screen.

### CROSS-REFERENCE TO RELATED APPLICATION

This patent application patent application claims the benefit of priority under 35 U.S.C. § 119 to U.S. Provisional Patent Application No. 63/678,771, filed Aug. 2, 2024, and entitled “VISUALIZATION TECHNIQUES FOR SPORTS TEAM MANAGEMENT,” which is incorporated herein by reference in its entirety.

### TECHNICAL FIELD

The present disclosure relates to a framework that enables efficient visualization and manipulation of analytical data associated with teams

### BACKGROUND

A large volume of information, as for example health metrics and performance metrics, is typically associated with sports teams. In order for an organization to visualize metrics and other information associated with a team, organizations generally use multiple applications in addition to a physical magnet board on which magnets representing team members may be positioned and manipulated. Notes may generally be added to the magnet board to effectively create a set of notes depicting a schema for the team. While a physical magnet board is useful to provide a team with an ability to visualize a schema, e.g., a depth chart, any changes to the schema are difficult to track.

### BRIEF DESCRIPTION OF THE DRAWINGS

FIG. 1A is a diagrammatic representation of an overall framework that enables visualization and manipulation of analytical data in accordance with an embodiment.

FIG. 1B is a diagrammatic representation of an overall framework, e.g., framework 100 of FIG. 1A, in more detail in accordance with an embodiment.

FIG. 2 is a block diagram representation of an application engine, e.g., application engine 104 of FIGS. 1A and 1B, in accordance with an embodiment.

FIG. 3A is a diagrammatic representation of a schema or a depth chart for a team in accordance with an embodiment.

FIG. 3B is a diagrammatic representation of first zoomed in view of a depth chart, e.g., depth chart 330 of FIG. 3A, in accordance with an embodiment.

FIG. 3C is a diagrammatic representation of second zoomed in view of a depth chart, e.g., depth chart 330′ of FIG. 3B, in accordance with an embodiment.

FIG. 4 is a diagrammatic representation of a depth chart, e.g., depth chart 330 of FIG. 3A, with a heat map in accordance with an embodiment.

FIG. 5 is a process flow diagram which illustrates a method of generating a depth chart and manipulating the depth chart in accordance with an embodiment.

FIG. 6 is a process flow diagram which illustrates a method of processing data to generate metrics and other information in accordance with an embodiment.

FIG. 7A is a diagrammatic representation of a depth chart interaction flow in accordance with an embodiment.

FIG. 7B is a diagrammatic representation of a real-time collaboration flow in accordance with an embodiment.

FIG. 8 is a diagrammatic representation of a depth chart or a schema which displays player cards in a collapsed configuration in accordance with an embodiment.

FIG. 9 is a diagrammatic representation of a depth chart or a schema which displays player cards in a default configuration in accordance with an embodiment.

FIG. 10 is a diagrammatic representation of a default player card, an expanded player card, and a collapsed player card in accordance with an embodiment.

FIG. 11 is a diagrammatic representation of a depth chart or a schema which shows a heat map in accordance with an embodiment.

FIGS. 12A and 12B are a process flow diagram which illustrates a method of interacting with a depth chart in accordance with an embodiment.

FIG. 13 is an illustration of a hardware block diagram of a computing device that may be used to support the processes described with respect to the preceding figures.

### DETAILED DESCRIPTION

### Overview

Techniques are presented herein that enable information relating to a team to be visualized and manipulated. Visualization techniques which enable managers of teams, e.g., sports teams, to efficiently obtain information about team members, e.g., players on sports teams, are disclosed. Visualization techniques may also enable roles or positions, as for example positions on rosters for sports teams, to be visualized. Cards such as player cards may be displayed as part of a schema, such as a depth chart, to enable information associated with various players to be readily viewed. The information that is provided on player cards may vary depending upon the view selected.

According to one embodiment, techniques described herein relate to a method including rendering a depth chart for a team for viewing on a display screen of a system, the team including personnel, the depth chart including at least one card, the at least one card include at least one parameter associated with the personnel, wherein the system enables a user to manipulate the depth chart. The method also includes identifying a manipulation of the depth chart, determining whether data used to render the depth chart has been updated, and updating the depth chart based on the manipulation, wherein when it is determined that the data has been updated, updating the depth chart further includes updating the depth chart based on the data that has been updated, and wherein updating the depth chart creates an updated depth chart. The method further includes rendering the updated depth chart for viewing on the display screen.

In another embodiment, one or more non-transitory computer readable storage media are encoded with instructions, that when executed by a processor, cause the processor to perform rendering a depth chart for a team for viewing on a display screen of a system, the team including personnel, the depth chart including at least one card, the at least one card include at least one parameter associated with the personnel, wherein the system enables a user to manipulate the depth chart. The process is further caused to perform identifying a manipulation of the depth chart, determining whether data used to render the depth chart has been updated, and updating the depth chart based on the manipulation. When it is determined that the data has been updated, updating the depth chart further includes updating the depth chart based on the data that has been updated, and wherein updating the depth chart creates an updated depth chart. Finally, the processor further performs rendering the updated depth chart for viewing on the display screen.

In still another embodiment, a system includes an analytics engine and an application engine. The analytics engine is configured to obtain data from at least one data source, the data including information about personnel on a team, the analytics engine further being arranged to process the data to obtain a plurality of analytics results associated with the team. The application engine includes an intelligent user interface (UI) layer, a position intelligence engine, a data persistence layer, and a state synchronization engine, wherein the application engine is configured to process the analytics results to generate a depth chart for display on a display screen of an endpoint and to render the depth chart in a first view on the display screen, the application engine further being configured to generate an updated depth chart based at least on a manipulation of the depth chart at the endpoint and to render the updated depth chart in a second view on the display screen.

In yet another embodiment, a method for dynamic team visualization includes: rendering a visualization of a team on a first display device, the visualization including one or more displayed elements, wherein the visualization is based on data associated with personnel of the team, and identifying a user interaction with the one or more displayed elements. The method also includes validating the user interaction, wherein validating the user interaction includes applying one or more formation-based constraints, determining whether the data has changed, and updating the visualization based on the user interaction to generate an updated visualization when the user interaction is validated, wherein updating the visualization includes applying any changes to the data when it is determined that the data has changed. Finally, the method includes synchronizing the updated visualization across a plurality of display devices including the first display device.

### Example Embodiments

Techniques are presented herein that enable a depth chart or a schema for a team to be presented, as for example displayed, such that components of the depth chart may be manipulated to effectively alter the composition of the team. The terms “depth chart” and “schema” may be used interchangeably. A framework allows data associated with a team, e.g., a sports team, to be visualized and analyzed to obtain metrics associated with the overall team and with team personnel, e.g., one or more members or players on a sports team. Although a team may be a sports team, it should be appreciated that a team is not limited to being a sports team or personnel associated with a sports team. For example, a team may refer to a group of employees of a company or an enterprise. The metrics may be presented as various schema rendered on a display screen. The metrics for team personnel may be rendered as a so-called “player card” on a display screen that may be manipulated by a user. That is, the player cards may be manipulated to change the composition of the team. The player cards may include different amounts and types of metrics pertaining to players based on the schema, or layout, in which the player cards are effectively displayed. Up-to-date information may be provided such that the visualization and the metrics may be relatively accurate at any given time.

The ability to visualize how a team may change based upon changes to personnel on the team provides a team manager with a comprehensive understanding of how the team may perform based on the change, and/or how the financial situation of the team may be impacted based on the change. If a particular player is added to a sports team to play a particular situation, the overall performance of the sports team may change, and the financial situation of the team may change based upon the salary that would be commanded by the particular player. In one embodiment, the visualization of the team may include an interface that enables a team manager to manipulate the visualization to effectively move the particular player into a specific position on the team. When the particular player is moved, metrics that reflect the performance of the team may be updated based upon the performance metrics of the particular player, and the overall financial condition of the team may also be updated based upon the financial metrics of the particular player.

In one embodiment, a framework allows public and confidential data associated with a team, e.g., a sports team, to be substantially analyzed to obtain metrics associated with the overall team and with team personnel, e.g., one or more members or players on the team. The public data may include, but is not limited to including, commercial databases. The confidential data may include, but is not limited to including, data internal to an organization such as a team. The data that is internal to an organization may include, but is not limited to including, performance data, biometric data, financial data, and/or character data that is not widely available. The metrics or analytical data associated with a team and personnel on the team may be presented as a depth chart or as various schema rendered on a display screen. Metrics presented at different levels of a depth chart may vary, e.g., a high level view of a team may include general metrics for the team and a lower level view of a team may include specific metrics for personnel on the team.

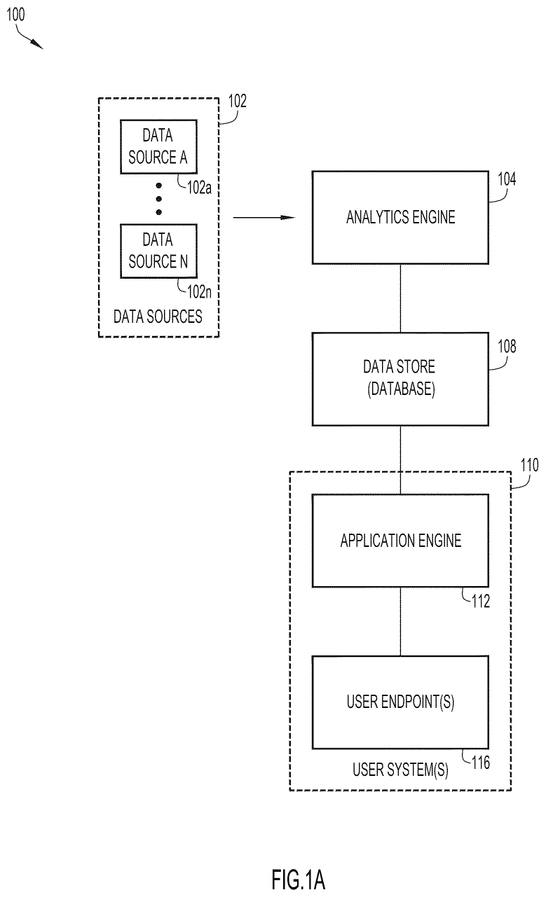

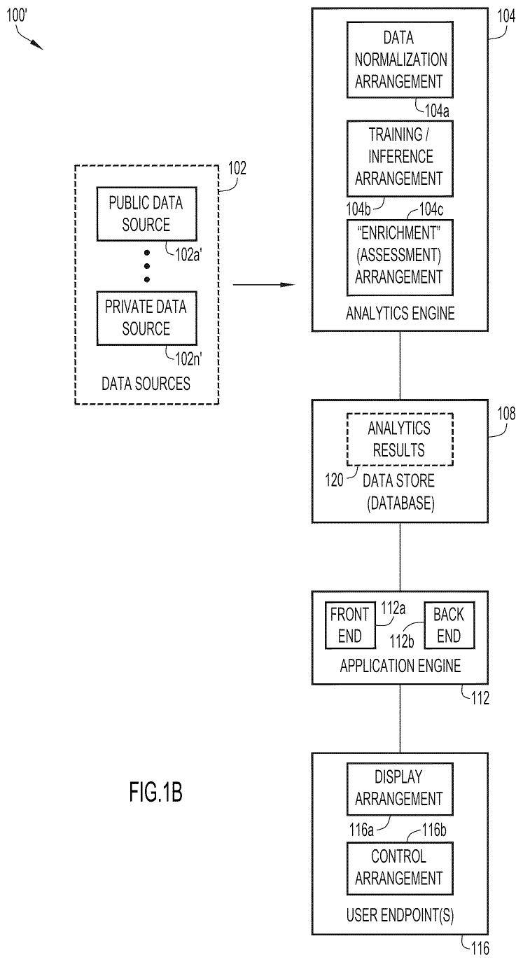

Referring initially to FIG. 1A, an overall framework that enables visualization and manipulation of analytical data associated with a team will be described in accordance with an embodiment. An overall framework 100 includes data sources 102, an analytics engine 104, a data store 108, and one or more user systems 110 that may each include an application engine 112 and a user endpoint 116. In one embodiment, data sources 102, analytics engine 104, and data store 108 may be remote with respect to user systems 110. For example, analytics engine 104 may be hosted on a server that is remote with respect to user systems 110. Although application engine 112 is shown as part of user systems 110, it should be appreciated that application engine 112 may instead be remote with respect to user systems 110 such that user systems 110 may be arranged to run an instance of an application associated with application engine 112.

Data sources 102 may include at least a first data source 102a and a second data source 102n. It should be appreciated that data sources 102 may vary widely, and may generally include publicly available data sources 102 as well as private or proprietary data sources 102. Further, the number of data sources 102 may vary widely, and may generally include one or more data sources 102a-n, and examples of the data provided by the data sources 102a-n are provided below. Analytics engine 104 may include one or more computing systems or servers which include logic encoded on one or more computer-readable media that, when executed by a processor (not shown) are arranged to obtain data from data sources 102 and to analyze or otherwise process the data. The one or more computing systems or servers may be part of a distributed network system. The data that is processed may include, but is not limited to including, biometrics, performance metrics, financial metrics, and metrics which may define the character of personnel. Data including the processed data may be stored in data store 108 such that one or more user systems 110 may access the processed data. It should be appreciated that data store 108 may include one or more databases, e.g., databases that are accessible on a network.

User systems 110 may communicate, as for example using network communications, with data store 108 such that data stored within data store 108 may be obtained. In one embodiment, user systems 110 effectively have access to an application engine 112 which may visually render data obtained from data store 108 and one or more user endpoints 116, each of which may include a computing system with a display screen that a user may use to display a depth chart which may include one or more schema with sets of metrics or information associated with personnel e.g., player cards. User endpoints 116 may also include components that enable a user to manipulate a depth chart, as for example by selecting and/or moving player cards rendered on a display screen. It should be appreciated that although user endpoints 116 have access to application engine 112, application engine 112 is generally hosted on a server that is remote with respect to user endpoints 116

With reference to FIG. 1B, an example of overall framework 100 will be described in more detail in accordance with an embodiment. In the described embodiment, framework 100′ may be utilized by an organization associated with a sports team. and may include data sources which include at least one public data source 102a′ and at least one confidential or private data source 102n′. Public data source 102a′ may be any suitable data source, as for example a data source which tracks personnel on various teams and/or a source of injury reports for players on teams. Public data source 102a′ may also include commercially available data sources which include information about sports teams and players on the sports teams. Private data source 102n′ may include data specific to a team that is not publicly available. For example, private data source 102n′ may be a data source maintained by a team that includes confidential information about personnel on the team.

Analytics engine 104 may be arranged to normalize data ingested from, or obtained from, data sources 102, and to determine metrics using the ingested data. Analytics engine 104 may also use the metrics to train intelligence associated with analytics engine 104, and may generate or otherwise provide assessments or insights into the generated using data ingested from data source 102. In one embodiment, analytics engine 104 is configured to enable a depth chart or a schema to be displayed such that assessments and/or insights may be rendered as part of the depth chart or the schema. For example, as will be described in more detail below, analytics engine 104 may provide information that enables a heat chart to be generated to indicate areas of relative strength and areas of relative weakness.

As shown, analytics engine 104 includes a data normalization arrangement 104a, a training/inference arrangement 104b, and an “enrichment” or assessment arrangement 104c. Data normalization arrangement 104a normalizes data ingested from, or obtained from, data sources 102. Training/inference arrangement 104b may determine metrics using ingested data, and may train any intelligence associated with analytics engine 104. “Enrichment” arrangement 104c is arranged to provide assessments or insights into analytics generated using data ingested from data sources 102.

Analytics results 120 generated by analytics engine 104 may be stored in data store 108 such that application engine 112 may access analytics results 120. Application engine 112 generally has a front end 112a and a back end 112b. Front end 112a may include functionality which enables one or more user endpoints 116 to interact with application engine 112, while back end 112b may include functionality which enables schemas or depths charts to be generated. One or more user endpoints 116 may each include a display arrangement 116a and a control arrangement 116b. Display arrangement 116a may be arranged to display or otherwise render a depth with player cards, and control arrangement 116b is arranged to enable a user to manipulate, adjust, and/or alter the depth chart and player cards.

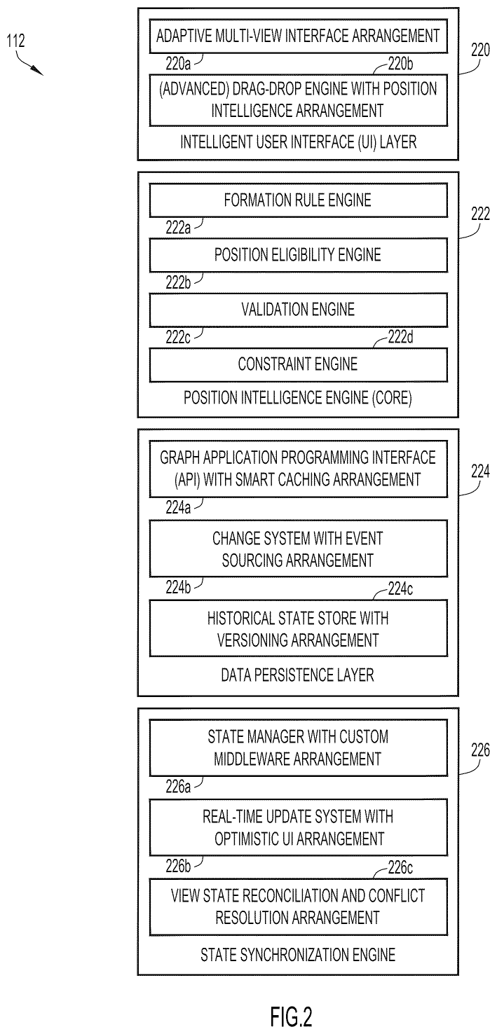

FIG. 2 is a block diagram representation of an application engine, e.g., application engine 112 of FIGS. 1A and 1B, in accordance with an embodiment. Application engine 112 may generally include hardware and/or software logic which, when executed by a processor, obtains information including analytics results and renders a depth chart. In the described embodiment, the architecture of application engine 112 includes an intelligent user interface (UI) layer 220, a position intelligence engine 222, a data persistence layer 224, and a state synchronization engine 226. In one embodiment, application engine 112 may further includes a page store component (not shown) for managing multiple saved depth chart configurations, thereby enabling users to save, load, and switch between different team arrangements.

Intelligent user UI layer 220 includes an adaptive multi-view interface arrangement 220a and a drag-drop engine with position intelligence arrangement 220b. Adaptive multi-view interface arrangement 220a provides an adaptive UI which may be modified or changed based on the needs and/or specifications of a user. Drag-drop engine with position intelligence arrangement 220b provides the ability for a user to interact with an adaptive UI to select a player card displayed in a first position with respect to a depth chart, drag the player card to a second position with respect to the depth chart, and drop the player card in the second position. In one embodiment, drag-drop engine with position intelligence arrangement 220b may have predictive capabilities that enable a prediction to be made as to where in the depth chart a user may drop a dragged player card. By way of example, drag-drop engine with position intelligence arrangement 220b may predict or otherwise anticipate a second location to which a player card may be dragged and subsequently dropped when a drag action is initiated to drag the player card from a first position. In one embodiment, drag-drop engine with position intelligence arrangement 220b provides predictive drop zone capabilities using machine learning that analyzes historical drag patterns, player position compatibility scores, formation requirements, and user behavior patterns. Drag-drop engine with position intelligence arrangement 220b may pre-calculate and highlight the most likely drop locations before a user completes a drag action with a player card and, thus, may reduce placement time.

Position intelligence engine 222 includes a formation rule engine 222a, a position eligibility engine 222b, a validation engine 222c, and a constraint engine 222d. In general, position intelligence engine 222 provides position management. Formation rule engine 222a may define rules associated with which areas a player card may be dropped into with respect to a particular team formation that is displayed in a depth chart. The rules may specify how formations may be constructed or defined. Position eligibility engine 222b may be configured to effectively define consistent player positions and, hence, which areas associated with positions rendered as part of a depth chart a particular player card may be dropped into. For example, position eligibility engine 222b may specify that players who play a certain position as effectively ineligible to play other positions. Validation engine 222c may be a multi-layered validation system which is configured to effectively ascertain whether a drag and drop operation has resulted in a player card being dropped into an appropriate location. Constraint engine 222d defines formation constraints which may be used by formation rule engine 222a to define rules. Constraint engine 222d may be a position constraint engine that dynamically validates player positions based at least on formation rules, team requirements, and/or player eligibility.

In one embodiment, position intelligence engine 222 employs a Zustand state management architecture with custom middleware including, but not limited to including, PlayersSlice, PositionsSlice, and DnDSlice for substantially maximizing performance and state synchronization. Formation rule engine 222a may implement specific grid layouts, as for example for approximately eleven personnel formations, in addition to a flexible ouzel coordinate system with position-specific zones. By way of example, a quarterback position on an American football team may be allocated coordinates (1400,900) with a 200×300 pixel drop zone.

Data persistence layer 224 includes a graph application programming interface (API) with smart caching arrangement 224a, a change system with event sourcing arrangement 224b, and a historical state store with versioning arrangement 224c. API with smart caching arrangement 224a is configured to enable caching to be accomplished. Change system with event sourcing arrangement 224b enables an audit trail to be created. Historical state store with versioning arrangement 224c is configured to store a current state of the depth chart along with a version indicator.

State synchronization engine 226 is arranged to enable real-time updates to be accounted for in a depth chart, and includes a state manager with a custom middleware arrangement 226a, a real-time update system with optimistic UI arrangement 226b, and a view state reconciliation and conflict resolution arrangement 226c. Custom middleware arrangement 226a processes real-time updates made to data and, hence, to a depth chart that is currently rendered and/or presented on a display screen of a user endpoint. Custom middleware arrangement 226a effectively enables differences associated a depth chart rendered on a user endpoint to be compared to current data. That is, custom middleware arrangement 226a may facilitate correlating a currently rendered depth chart against current data. Real-time update system and optimistic UI arrangement 226b enables a depth chart to be updated substantially when real-time updates are available, while the depth chart is rendered and/or presented on a display screen for viewing. In one embodiment, real-time update system and optimistic UI arrangement 226b may provide a notification to a user endpoint to inform a user about the availability of updated data, View state reconciliation and conflict resolution arrangement 226c may identify when the state of a depth chart that is rendered on a user endpoint for viewing is not consistent with current data, and may reconcile conflicts or differences between the state of the depth chart and the current data.

Data persistence layer 224 may implement an event-sourced architecture in which each modification to a depth chart may be stored as a substantially immutable event with a timestamp, a user identifier, a previous state, a new state, and/or a change type for a relatively complete audit trail reconstruction.

Analytics results, e.g., analytics results 120 of FIGS. 1A and 1B, that are generated by analytics engine 104, are used to provide information rendered in a schema or a depth chart. For example, analytics results for a sports team may include metrics and other information which may be displayed in player cards, and generally used to create views associated with a schema or a depth chart.

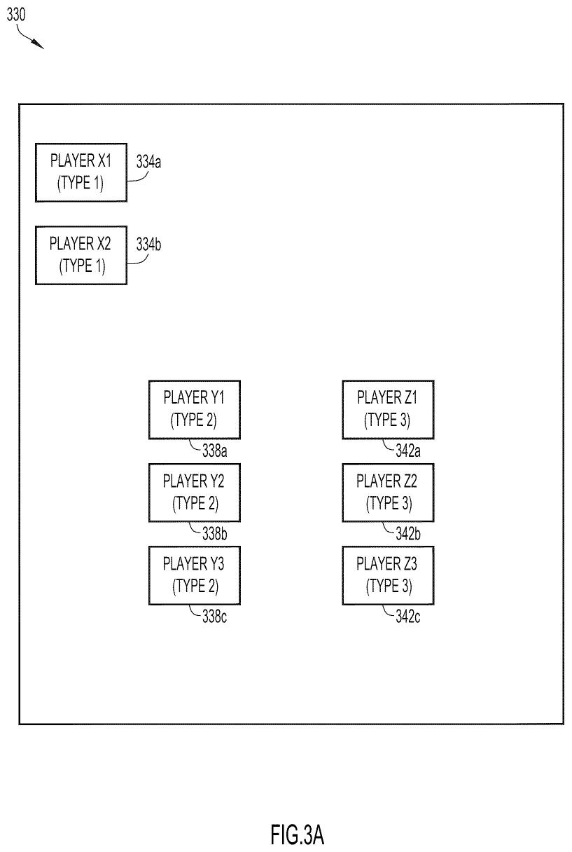

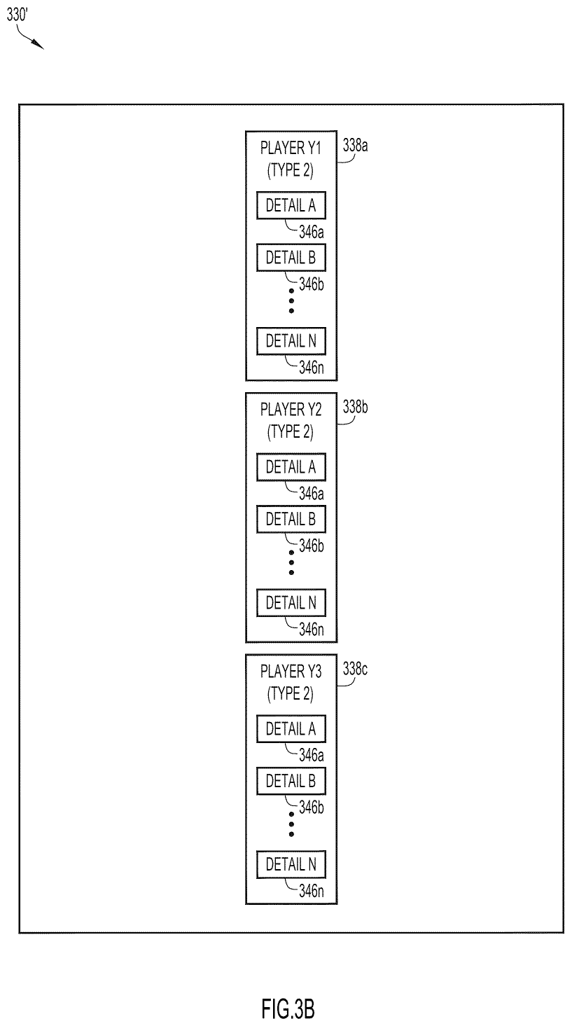

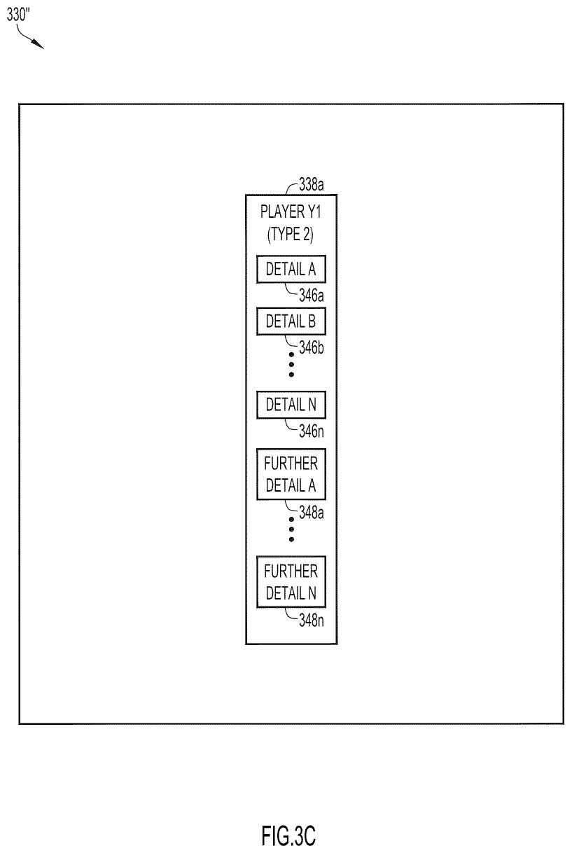

FIG. 3A is a diagrammatic representation of a schema or a depth chart for a team in accordance with an embodiment. A schema or a depth chart 330 is arranged to be rendered or otherwise displayed on a display screen for viewing. For example, depth chart 330 may be displayed on a display screen of a device that a user may use to interact with depth chart 330, and may be configured such that the user may effectively manipulate depth chart 330. In the described embodiment, depth chart 330 is a macro-view of first dimension arranged to include player cards 334a, 334b for players of “Type 1,” player cards 338a-c for players of “Type 2,” and player cards 342a-c for players of “Type 3.” Although the depth chart 330 provides a view of players on a sports team, it should be appreciated that the players on the sports team may generally be considered to be personnel of any team.

In one embodiment, when players are American-style football players, the types of players may correspond to American-style football positions including offensive positions and defensive positions. For example, player card 334a and player card 334b may be for players playing the same first position, player cards 338a, 338b, and 338c may be for players playing the same second position, and player cards 342a, 342b, and 342c may be for players playing the same third position.

As shown, depth chart 330 may include player cards 334a and 334b, player cards 338a-c, and player cards 342a-c displayed in groups or sets in a first layer of depth chart 330. For example, a first player associated with player card 338a may be considered to be a primary player at a particular position, a second player associated with player card 338b may be a secondary player at the particular position, and a third player associated with player card 338c may be a tertiary player at the particular position. It should be appreciated that a user may manipulate player cards such as player cards 338a-c to change the order associated with depth chart 330, as for example by selecting a particular player card and “dragging and dropping” the particular player card in a desired location with respect to depth chart 330.

Player cards such as player cards 338a-c may include a first amount of detail, and may be considered to be in a collapsed format. The first amount of detail may include a first set of information appropriate to the size of player cards 338a-c within depth chart 330. The first amount of detail may include, in one embodiment, a name and a depth order or a player within their position group, e.g., the position rank of a player such as a quarter back may be “first string quarterback.”.

A user may zoom in on player cards 338a-c, or otherwise expand player cards 338a-c to display more detail associated with player cards 338a-c as shown in FIG. 3B. That is, a user may display a second dimension associated with depth chart 330. FIG. 3B is a diagrammatic representation of a first zoomed view of depth chart 330 in accordance with an embodiment. Depth chart 330′ depicts player cards 338a-c in more detail, e.g., including contextual data. As a user zooms in within depth chart 330′, a second amount of detail may be provided on player cards 338a-c. In one embodiment, the second amount of detail may correspond to a default amount of detail for player cards 338a-c. As shown, each player card 338a-c may include at least details 346a, 346b, and 346n. Details 346a-n may be attributes associated with a player. Details 346a-n may include, but are not limited to including, a name of a player, a position of the player, a rank of the player, an age of the player, a height and weight of the player, and a grade or rating of the player. That is, details 346a-n may include biometric data and performance analytics, such as a percentage of passes caught for a wide receiver, an average number of yards per pass caught for a wide receiver, and/or an average number of yards after catch for a wide receiver. It should be appreciated that the performance analytics may generally vary based upon the position of a player. For example, performance analytics for a quarterback may encompass how many passes are thrown and how many passes are completed, while performance metrics for a defensive lineman may encompass how many tackles and how many quarterback sacks are registered. The grade or rating may be determined by an analytics engine such as analytics engine 104 of FIGS. 1A and 1B.

A user may elect to zoom in further with respect to depth chart 330′ and, hence, cause still more information about players to be displayed in a third dimension. For example, a user may select player card 338a to zoom in on and, hence, obtain additional information about a player associated with or effectively described by player card 338a. As shown in FIG. 3C, player card 338a includes a third amount of detail, and may be considered to be a substantially fully expanded view of depth chart 330″. Expanded view includes details 346a-n, as well as further details 348a-n. Further details 348a-n may include, but are not limited to including, a salary cap amount (referred to herein as a “cap” amount) associated with the player and an assessment of the character of the player. A team may be allowed a substantially maximum total salary expenditure across all of its players, and this amount is referred to as a salary cap. Moreover, the compensation to a given player may have an associated impact or contribution to the aggregate team salary cap. The character of a player may generally include, but is not limited to including, an assessment of the temperament of the player and an assessment of known disciplinary issues of the player.\

A depth chart or a schema may generally include a heat map which may effectively draw attention to particular areas of the depth chart, as for example particular positions on a team that have relatively high salaries or spend and particular positions on a team that have relatively low salaries or spend. That is, a depth chart may be rendered or otherwise displayed with a heat map which may highlight particular positions based on a criterion such as salaries associated with the particular positions. It should be understood that a heat map or highlighting is not limited to being based on salaries, and that the criterion used to generate a heat map may vary widely.

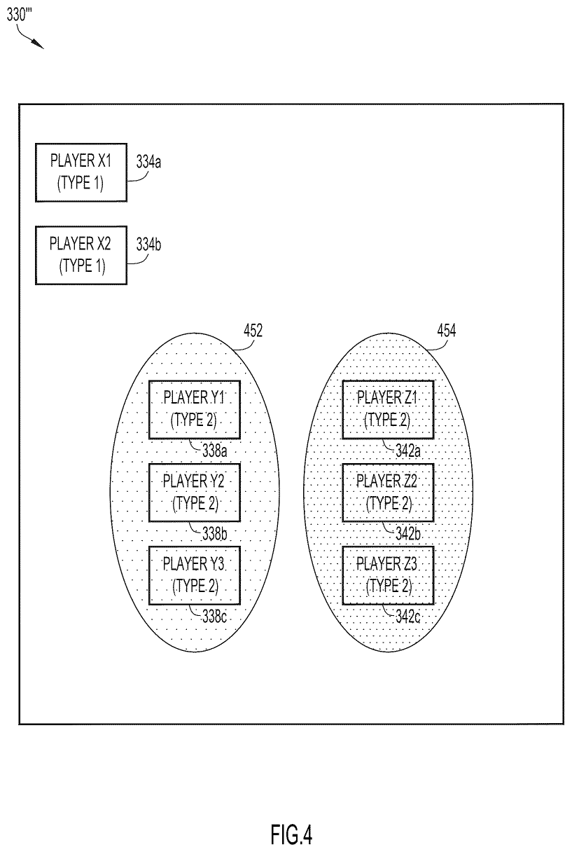

FIG. 4 is a diagrammatic representation of a depth chart, e.g., depth chart 330 of FIG. 3A, rendered with a heat map or highlighting in accordance with an embodiment. Depth chart 330′″ includes heat map area 452 which is arranged to indicate an area of relatively high spend with respect to salaries and heat map area 454 which is arranged to indicate an area of relatively low spend with respect to salaries. As such, depth chart 330′″ indicates that a team is spending a relatively large amount on players of “Type 2” and spending a relatively low amount on players of “Type 3.” Heat map area 452 may effectively be highlighted first color while heat map area 454 may effectively be highlighted with a second color, and/or heat map area 452 may have a different intensity or brightness than heat map area 454. In general, heat map area 452 and heat map area 454 may have different display characteristics such that heat map area 452 and heat map area 454 may effectively be differentiated.

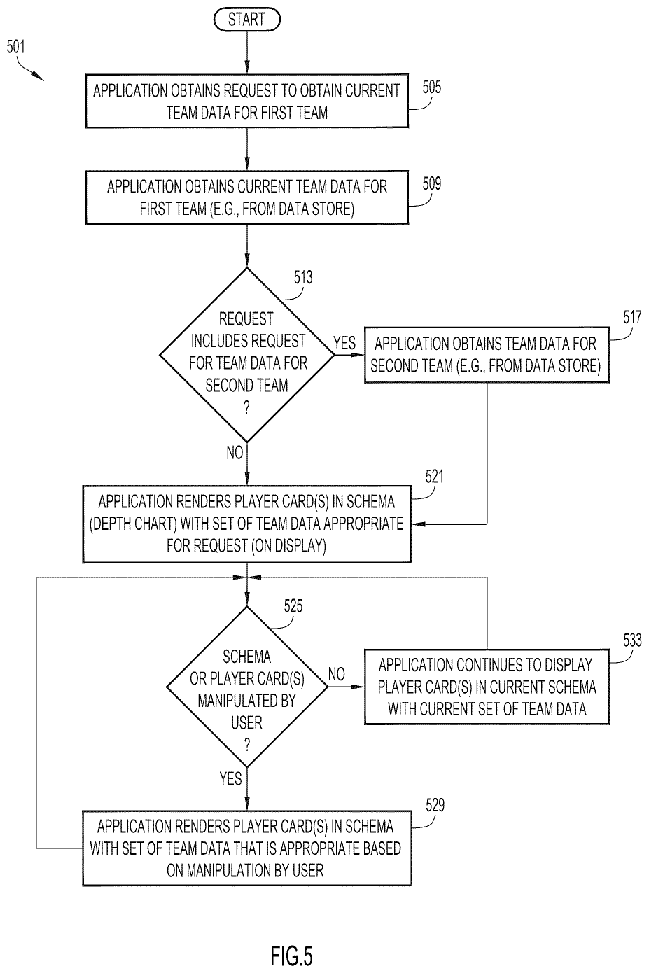

FIG. 5 is a process flow diagram which illustrates a method of generating a schema or a depth chart, and manipulating information rendered in the schema or depth chart, in accordance with an embodiment. A method 501 of generating a schema and manipulating information rendered in the schema begins at a step 505 in which an application obtains a request to obtain current team data for a first team. The request may be obtained when a user accesses the application, and effectively instructs the application to provide current team data, e.g., analytics for personnel and/or “enrichment” information for the personnel. In one embodiment, the user may access an instance of an application on his or her computing device, and the instance of the application may access remote resources such as a data store. In another embodiment, the user may access an application hosted on a remote server, and the application may access resources such as a data store.

In a step 509, the application obtains current team data for the first team, as for example from a data store in which an analytics engine stores analytics results after running analytics on data associated with personnel or players on the team. After the application obtains current team data for the first team, a determination is made in a step 513 as to whether the request includes team data for a second team, e.g., such that head-to-head matchups between the first team and the second team may be compared. If the determination is that the request includes a request for team data for a second team, the application obtains team data for the second team in a step 517, e.g., from a data store.

From step 517, or when the request to obtain current team data for the first team does not include a request for team data for a second team, process flow proceeds to a step 521 in which the application renders one or more player cards in a schema with the set of team data appropriate to address the request. Typically, a schema consistent with the request to obtain current team data for the first team may be rendered as player cards on a display screen of a user system such as a computing system in the possession of a user.

After the application renders the one or more player cards, a user of the application may manipulate the depth chart or schema by manipulating player cards. For example, the user may select a new depth chart or schema to render, the user may select a new view for a depth chart or schema, and/or the user may effectively reposition player cards.

A determination is made in a step 525 regarding whether the schema, or one or more player cards rendered on the schema, have been manipulated by the user. The user may select a particular schema, which may be a list, to display. That is, the user may select a particular view of player cards and, hence, may essentially select the type of data to display with respect to the player cards. The user may also select personnel to view, e.g., offensive personnel or defensive personnel for an American football team, by selecting appropriate filters. If it is determined that there has been no manipulation of a rendered schema or player card, the application continues to display one or more player cards in the currently rendered schema with the current set of team data in a step 533. From step 533, process flow returns to step 525 in which it is determined whether the schema, or one or more player cards, have been manipulated by the user.

Alternatively, if it is determined in step 525 that the schema, or one or more player cards, has been manipulated by the user, the application renders the one or more player cards as appropriate based on the manipulation performed by the user in a step 529. That is, the application effectively updates the depth chart or schema displayed to the user based upon actions taken by the user, e.g., the repositioning of one or more player cards or a request to zoom in on a portion of a current depth chart or schema. It should be appreciated that the user may take actions that include, but are not limited to including, manipulating filters such as a biometric filter, an analytics filter, and a biographical filter. After the application renders the one or more player cards, process flow returns to step 525 in which it is determined whether the schema, or one or more player cards, have been manipulated by the user.

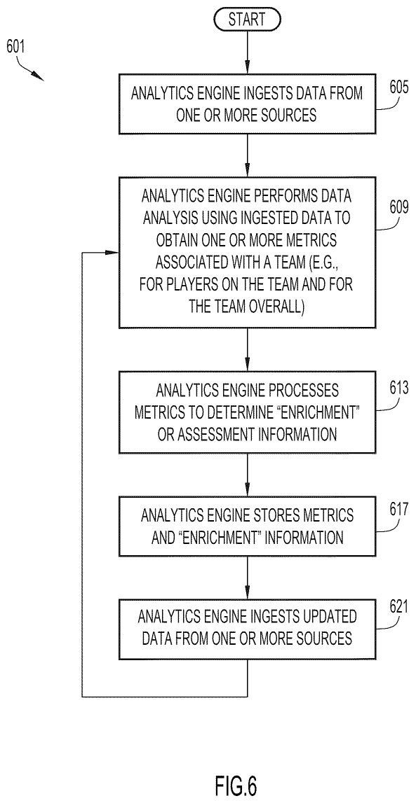

As previously mentioned, data obtained by an analytics engine may be processed to generate metrics and other information, as for example “enrichment” information such as a suggestion regarding a player or personnel. Referring next to FIG. 6, a method of processing data to generate metrics and other information will be described in accordance with an embodiment. A method 601 of processing data begins at a step 605 in which an analytics engine ingests or otherwise obtains data from one or more sources. After ingesting the data, the analytics engine performs data analysis using the ingested data to obtain one or more metrics associated with a team, as for example for individual players and for an overall team, in a step 609. The metrics may include, but are not limited to including, biostatistical data, performance data, financial data, and/or character data.

From step 609, process flow proceeds to a step 613 in which the analytics engine processes metrics to determine “enrichment” or assessment information. Processing the metrics may include determining how much an overall team may improve if a one player is replaced by another player, and determining “enrichment” or assessment information may include generating a recommendation as to whether a particular player should be acquired or replaced. Once the “enrichment” or assessment information is determined, the analytics engine stores the metrics and “enrichment” information in a data in a step 617, e.g., in a data store such as a database.

In a step 621, the analytics engine ingests or otherwise obtains updated data from one or more sources. For example, after a game is played, raw player data may change based on how players perform during the game. As such, player data is updated. Player data may also be updated due to injury, due to a player being traded, due to a player becoming available in free agency, etc. The updated data may be ingested periodically, upon demand when data analysis is to be performed, and/or substantially any time updated data is available. After the analytics engine obtains updated data, process flow returns to step 609 in which the analytics engine performs data analysis using the new data.

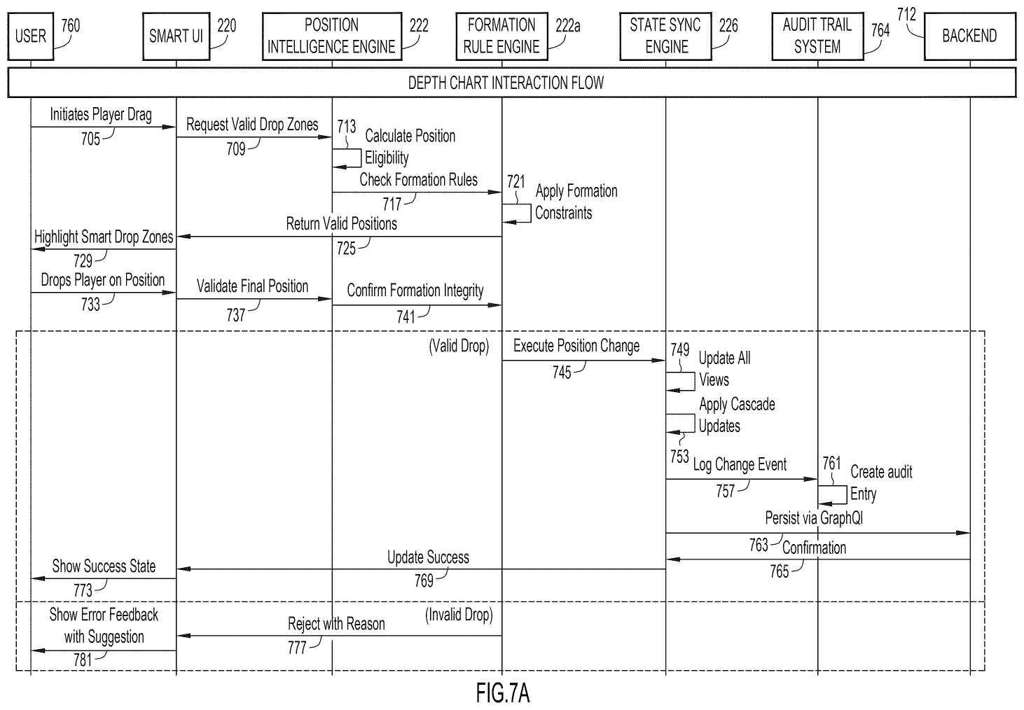

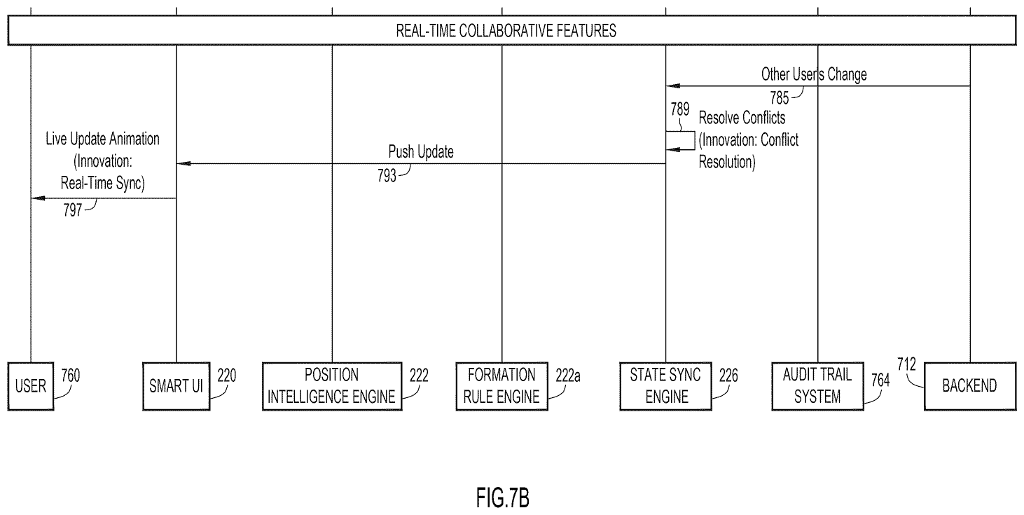

In general, when a depth chart is rendered on a display screen of a user endpoint, e.g., a display screen or a computing system of a user, the user may manipulate the depth chart. When the user manipulates or otherwise interacts with the depth chart, various interactions occur with respect to elements within an overall system, e.g., system or framework 100 of FIGS. 1A and 1B. FIG. 7A is a diagrammatic representation of a depth chart interaction flow in accordance with an embodiment.

A user 760, using a user endpoint, initiates a player card action, e.g., a “player drag,” at a step 705. User 760 may initiated the player draft by selecting a player card and beginning to draft the player card to a different position with respect to a depth chart. The initiation of a player drag by user 760 effectively involves an interaction with smart or intelligent user UI layer 220.

When smart UI layer 220 detects a player drag, smart or intelligent user UI layer 220 requests one or more valid drop zones from position intelligence engine 222 in a step 709. Upon requesting one or more valid drop zones, or zones in the depth chart which may effectively accept the dragged player card, position intelligence engine 222 calculates or otherwise determines position eligibility for the player associated with the dragged player card in a step 713. That is, position intelligence engine 222 determines whether the player associated with the dragged player has a position that is consistent with where user 760 may be attempting to drag the player card. For example, if the player is a defensive lineman, position intelligence engine 222 may determine that the player card of the player is not suitable for dragging and dropping into a zone on the depth chart that is associated with a quarterback.

In a step 717, position intelligence engine 222 checks the position eligibility formation rule engine 222a for formation rules that are applicable to the player card. Formation rule engine 222a may apply one or more formation constraints in a step 721. For example, if the player associated with the player card is an offensive skills player, formation constraints may indicate that the player card may be dragged and dropped into a zone for different offensive skills positions but may not be dragged and dropped into a zone for offensive line positions. Applying one or more formation constraints may generally include identifying valid positions for the player identified in the player card and, hence, valid zones within the depth chart to which the player card may be dragged and dropped. The formation constraints may be provided to formation rules engine 222a by a constraint engine included in position intelligence engine 222.

In one embodiment, formation rule engine 222a may execute a method or an algorithm which 1) loads a formation constraint matrix for a selected formation type, 2) calculates an eligible drop zone for each player position using validZones=formation.positions.filter(pos=>player.eligiblePositions.includes(pos) && pos.currentDepth<pos.maxDepth), 3) applies formation-specific spacing rules with a substantially minimum number of pixels between players, e.g., 150px, and 5) returns an array of valid coordinates with confidence scores.

Valid positions for the selected player card may be provided in a step 725 by formation rule engine 222a to smart or intelligent user UI layer 220. In one embodiment, providing valid positions may include effectively predicting where user 760 may intend to place the selected player card. Smart UI 30 may, in a step 729, highlight smart drop zones, e.g., drop zones into which the selected player card may be dropped, such that user 760 may view smart drop zones into which user 760 may drop the player card to substantially complete a drag and drop action. Highlighting the smart drop zones may include displaying a particular color or brightness to identify the smart drop zones, although it should be appreciated that any suitable method may be used to highlight or otherwise bring attention to the smart drop zone. In one embodiment, a smart drop zone is defined around a particular position such that if the selected player card is dropped in the smart drop zone, the player card ay be added to the particular position.

In a step 733, user 760 may drop the selected player card into a position within respect to the depth chart using the smart or intelligent user UI layer 220. Once user 760 drops the selected player card into a position, information relating to where the selected player card is dropped is obtained by position intelligence engine 222 in a step 737 to enable position intelligence engine 222 to validate the position, e.g., the final position, associated with where the selected player card is dropped.

In a step 741, position intelligence engine 222 utilizes formation rule engine 222a to determine whether the selected player card has been dropped into a valid position, i.e., whether the drop of the player card is valid or whether formation integrity is maintained. When formation integrity is effectively confirmed, and the indication is that the selected player card has been dropped into a valid position, the position change for the player card is effectively executed in a step 745 by state synchronization engine 226. For example, data used to generate the depth chart is updated to indicate the position change, and analytics associated with the player associated with the selected player card and the team may be updated based on the position change,

Substantially all views associated with a depth chart are updated by state synchronization engine 226 in a step 749. Then, in a step 753, state synchronization engine 226 applies cascade updates. That is, state synchronization engine 226 causes appropriate updates to be made to data based on updates associated with the movement of the selected player card to a new location within the depth chart. Cascade updates may involve, but are not limited to involving, identifying substantially all positions affected by player movement, recalculating depth orders for each affected position group, updating formation-specific constraints, revalidating substantially all player positions, and propagating changes to substantially all connected clients or users.

A change event associated with the movement of the selected player card to a new location within the depth chart is effectively logged by an audit trail system 764, which may be associated with data persistence layer 224 of FIG. 2, in a step 757. An audit trail system may be configured to maintain a substantially complete history of depth chart modifications. An audit entry is then created by audit trail system 764 at a step 761.

In a step 763, state synchronization engine 226 provides a persist instruction to a backend 712 using a GraphQL. Backend 712 may provide, or otherwise send, a confirmation in a step 765 to state synchronization engine 226. Upon obtaining the confirmation, state synchronization engine 226 provides an update or notification in a step 769 to smart or intelligent user UI layer 220 which indicates success of the drag and drop action of the player card. Smart or intelligent user UI layer 220, after obtaining the updated, displays or otherwise shows a success state in a step 773 such that user 760 may effectively be notified of the success state.

Returning to step 741, if formation rule engine 222a determines that the player card has not been dropped into a valid position, formation rule engine 222a identifies a reason for a rejection of the drag and drop action in a step 777, and provides a rejection notification to smart or intelligent user UI layer 220. For example, formation rule engine 222a may provide a rejection notification which indicates that the position into which the drag and drop action for the selected player card is inconsistent with the position typically played by the player associated with the selected player card. In a step 781, smart or intelligent user UI layer 220 may provide error feedback to user 760, and may provide a suggestion as to where the selected player card may be moved that may be consistent with the position typically played by the player associated with the selected player card.

In one embodiment, multiple users may access a depth chart, and may also each effectively edit the depth chart, e.g., by moving one or more player cards. Multiple user may, therefore, collaborate substantially in real-time to edit a depth chart. The depth chart may be edited substantially simultaneously, and real-time conflict resolution and live synchronization may facilitate collaboration among multiple user of the depth chart. FIG. 7B is a diagrammatic representation of a real-time collaboration flow in accordance with an embodiment. At a step 785, a change made to a depth chart by another, e.g., second, user are provided from backend 712 to state synchronization engine 226. That is, while user 760, e.g., a first user, is interacting with a depth chart or has a depth chart displayed on a first endpoint, a second user may make a change to the depth chart displayed on a second endpoint while the user 760 is interacting with the depth chart or has the depth chart displayed on the first endpoint.

In a step 789, state synchronization engine 226 effectively resolves conflicts between the user 760 and the second user. In other words, state synchronization engine 226 processes and resolves conflicts between manipulations made to the depth chart by the user 760 and manipulations made to the depth chart by the second user. Conflict resolution may generally include resolving conflicts when user 760 and the second user are essentially making simultaneous changes or edits to the depth chart. In one embodiment, state synchronization engine 226 may resolve conflicts using a hybrid, operational transformation approach. For example, when concurrent edits occur, as for example on depth charts displayed on display screens for different clients or users, the system may apply a deterministic ordering based on, but not limited to being based on, user priorities and timestamps, and may generate compensating operations for conflicts. Once compensating operations for conflicts are generated, a resolution may be broadcast to substantially all clients, e.g., within approximately one hundred milliseconds. The broadcasted resolution may effectively cause an updated visualization of a depth chart to be rendered on display screens for substantially all clients.

After conflicts are resolved, an update is pushed to smart or intelligent user UI layer 220 by state synchronization engine 226 in a step 793. The update may provide current states to be included in the depth chart. In a step 797, smart or intelligent user UI layer 220 effectively provides a live update animation to user 760, as for example to a display screen on a user endpoint of user 760. That is, the live update animation is provided as part of a real-time synchronization.

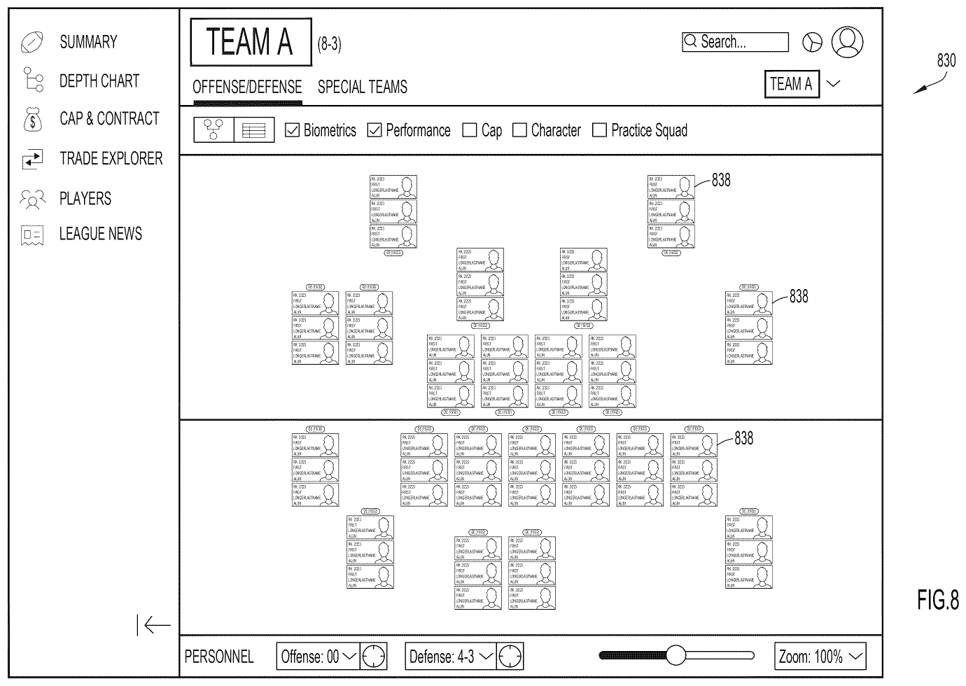

With reference to FIGS. 8-11, examples of depth charts or schemas which include player cards will be described in accordance with an embodiment. For purposes of illustration, the depth charts of FIGS. 8-11 are associated with teams which are composed of players. It should be appreciated, however, that depths charts are not limited for use with teams of players. In general, any suitable team or organization of personnel may be organized in a depth chart or a schema.

FIG. 8 is a diagrammatic representation of a depth chart which displays player cards in a collapsed configuration in accordance with an embodiment. Within a depth chart 830, player cards 838 are shown in a collapsed view such that a first amount of detail or information, as for example a player name and a player ranking, are provided on player cards 838. As shown, player cards 838 may be grouped, organized, or clustered together based on any suitable criteria. For example, player cards 838 may be organized based on positions on a team.

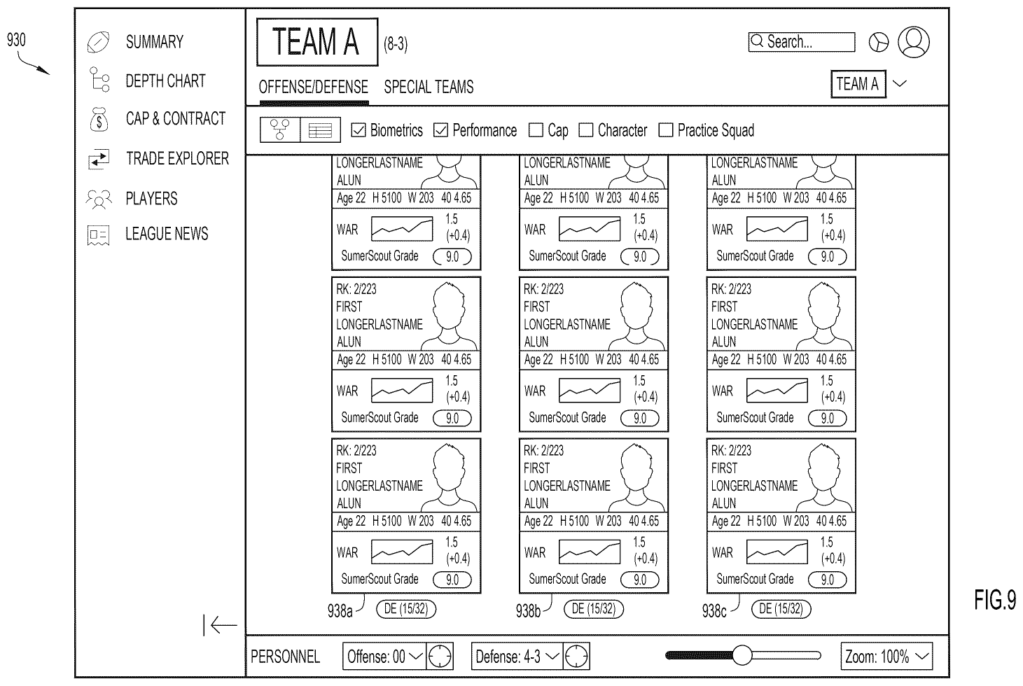

FIG. 9 is a diagrammatic representation of a depth chart which displays player cards in a default configuration in accordance with an embodiment. Within a depth chart 930, when player cards 938a-c are in a default configuration, a second amount of detail or information associated with each player may be displayed or rendered. The default configuration of player cards 938a-c may be used when a particular group of players is associated with player cards 938a-c. In the described embodiment, player cards 938a-c are associated with defensive players of a football team such that player cards 938a, 938c are cards for defensive ends (DEs), and player cards 938b are cards for defensive tackles (DTs).

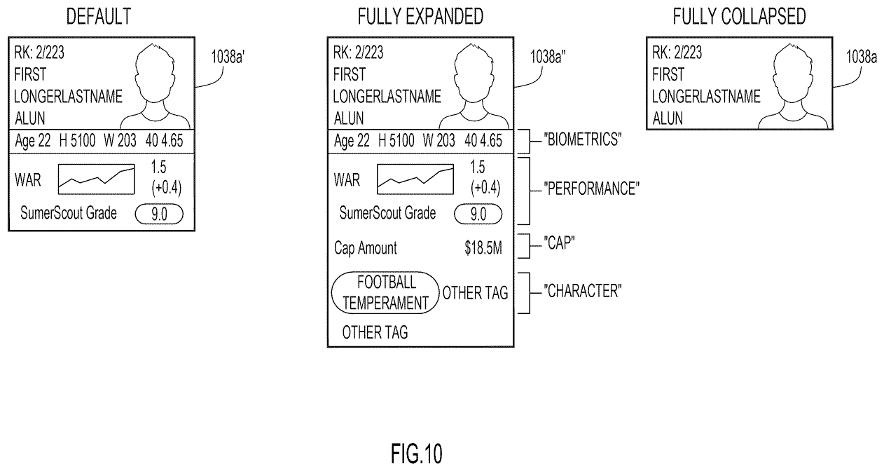

A player card, such as player card 338a of FIGS. 3A-3C, may have different views and, thus, different information which may be displayed depending upon the zoom level of the player card within a depth chart or an environment. For example, in a zoomed out view, a player card may be shown with a first amount of detail, and in a zoomed in view, a player card may be shown with a second or greater amount of detail. FIG. 10 is a diagrammatic representation of a default player card, an expanded player card, and a collapsed player card in accordance with an embodiment. A first or collapsed view of a player card 1038a may include a first amount of detail. While the first amount of detail may vary, the first amount of detail may identify a name of a player and a rank of the player. In general, first view of player card 1038a may be shown in a depth chart that may include substantially an entire team.

A second view or default view of a player card 1038a′ may include a second amount of detail. The second amount of detail may include, but is not limited to including, a name of a player, a rank of the player, an age of the player, a height and weight of the player, and a grade assigned to the player based on data analytics performed using data associated with the player. The height and weight of the player may be considered to be biometric data about the player. The grade assigned to the player may be considered to be data concerning the performance of the player. Second view of player card 1038a′ may be shown, for example, in a depth chart that includes all players which a particular function on a team, e.g., all offensive players on an American football team.

A third view or expanded view of a player card 1038a″ may include a third amount of detail which, in one embodiment, is a greater amount of detail than shown in second view of player card 1038a′. In addition to the detail shown in second view of player card 1038a′, third view of player card 1038a″ may also include information related to the cap amount associated with the player, as well as a character of the player, e.g., a metric which is an indication of a temperament of the player with respect to an American football team. It should be appreciated that the amount of data shown and/or the type of data shown for each player in either first view of player card 1038a, second view of player card 1038a′, and third view of player card 1038a″ may be configurable and, hence, may vary widely.

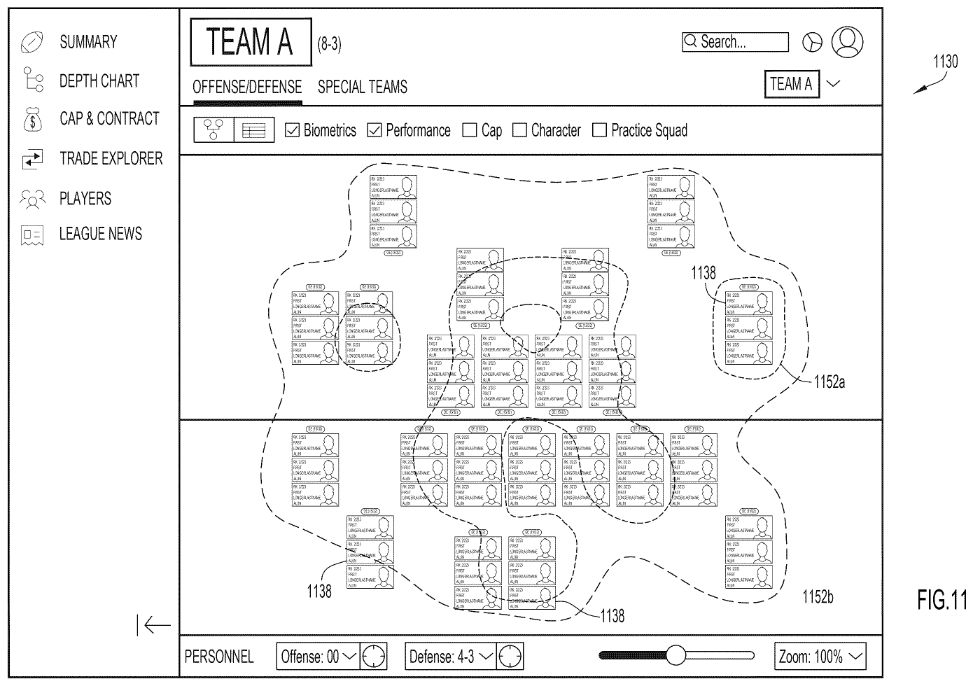

As discussed above with respect to FIG. 4, a depth chart may include a heat map to highlight particular areas, e.g., particular areas in which a team may have strengths and particular areas in which a team may have weaknesses. The use of a heat map may provide a user with an ability to readily identify the areas of strength and the areas of weaknesses with respect to a particular parameter or feature. FIG. 11 is a diagrammatic representation of a schema which shows a heat map in accordance with an embodiment. In schema or depth chart 1130, player cards 1138 are shown with a heat map area 1152a and a heat map area 1152b. Heat map area 1152a has a different “heat level” than heat map area 1152b and, thus, may indicate different levels associated with a particular metric. In the embodiment as shown, heat levels may be such that team spend on particular positions is depicted by heat map area 1152a and heat map area 1152b, with heat map area 1152a being an area of relatively high spend and heat map area 1152b being an area of relatively low spend. Thus, the use of a heat map may provide insight how financial resources are allocated within the team.

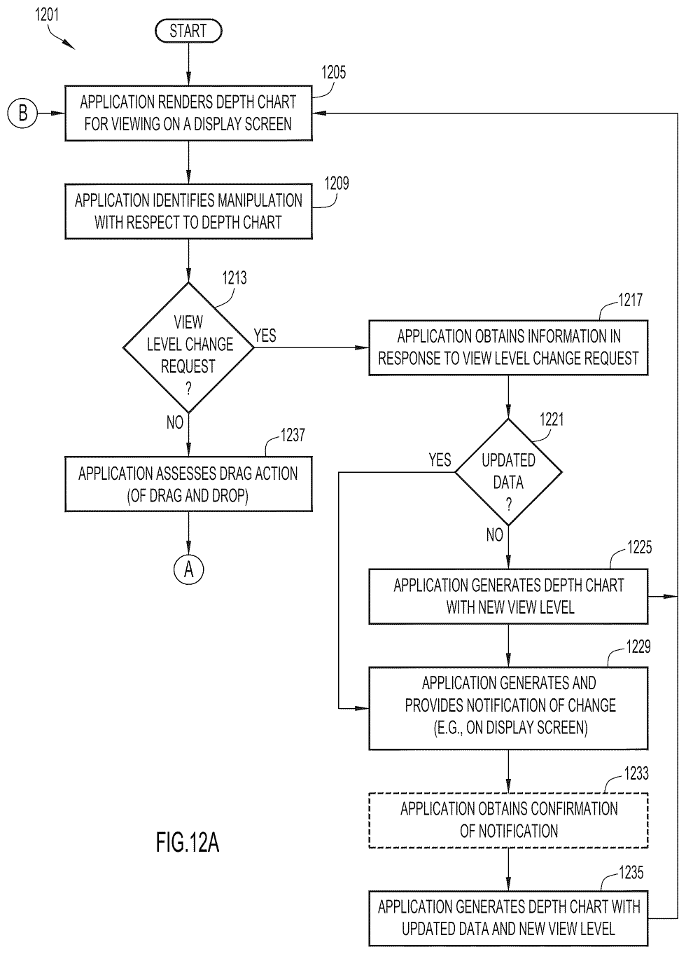

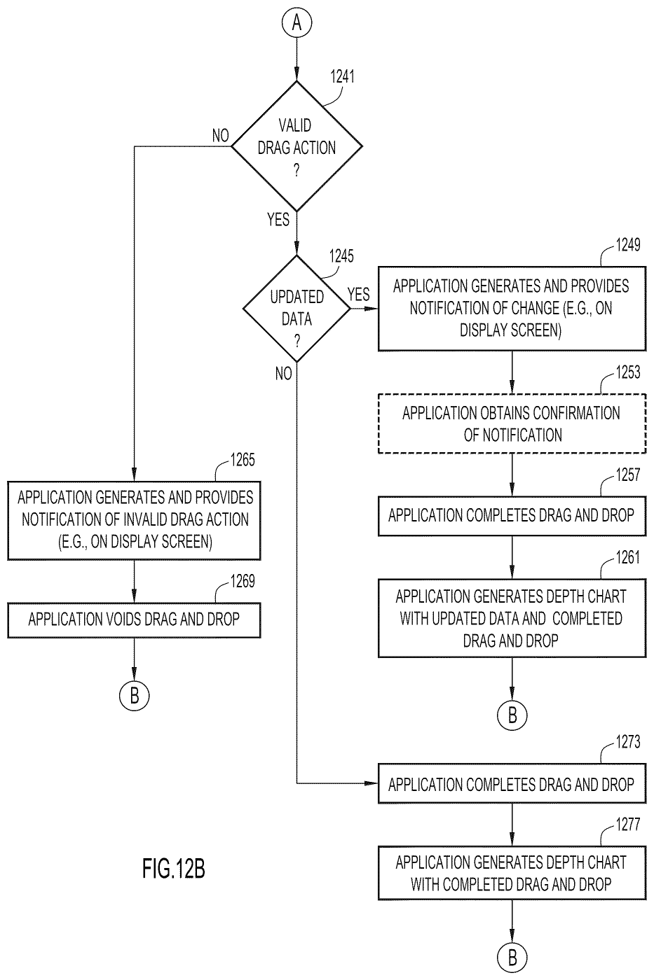

With reference to FIGS. 12A and 12B, a method of interacting with a depth chart displayed or rendered for viewing on a display screen of a user endpoint will be described in accordance with an embodiment. A method 1201 of interacting with a depth chart begins at a step 1205 in which an application renders a depth chart for viewing on a display screen of a user endpoint.

In a step 1209, the application identifies a manipulation or an edit with respect to the depth chart. For example, the application identifies a change in a view level, such as when a different amount of data is to be shown in a player card, or a drag and drop action.

After the application identifies a manipulation, it is determined in a step 1213 whether the manipulation is a view level change request. If it is determined that the manipulation is a view level change request, the application obtains information in response to the view level change request in a step 1217. For example, the application may obtain additional information about a player with a player card that is to be zoomed in on when the view level of a depth chart is changed.

From step 1217, process flow proceeds to a step 1221 in which it is determined whether there is updated data associated with the depth chart. By way of example, it may be determined whether information associated with a formation or positions displayed on the depth chart has been updated. Updated data may include, but is not limited to including, changes in salary, changes in a player rank, changes in the availability of players, etc. If the determination is that there is no updated data associated with the depth chart, the application generates the depth chart with the new view level in a step 1225. Once the depth chart with the new view level is generated, process flow returns to step 1205 in which the application renders the depth chart with the new view level for viewing on the display screen.

Alternatively, if it is determined in step 1221 that there is updated data associated with the depth chart, the application generates a notification, and provides a notification which indicates that there is updated data in a step 1229. The notification may generally be rendered on the display screen such that a user may note that data has been updated. In an optional step 1233, the application obtains confirmation of the notification from the user, e.g., through the user interacting with an UI rendered on the display screen. In a step 1235, the application generates the depth chart with the new view level using the updated data. After the application generates the depth chart, the application renders the depth chart for viewing on the display screen in step 1205.

Returning to step 1213, if it is determined that the manipulation is not a view level change request, the indication is that the manipulation is a drag and drop action in which a user has selected a player card and is dragging the player card with respect to the depth chart. That is, the manipulation is a drag action that effectively initiates an overall drag and drop action. As such, the application assesses the drag action in a step 1237, and process flow proceeds to a step 1241 in which a determination is made as to whether the drag action is valid. In other words, it is determined whether the drag action results in an attempt to drop the player card at a valid location in the depth chart. The valid location may be associated with a formation and/or a position that the player in the player card may play.

If it is determined that the drag action is valid, then in a step 1245, it is determined whether data associated with the depth chart has been updated. If the determination is that data has been updated, then the application generates and provides a notification of changed, or updated, data in a step 1249. The notification may be rendered on or displayed on a display screen of a user endpoint. In an optional step 1253, the application may obtain confirmation of the notification.

From step 1249 or optional step 1253, process flow moves to a step 1257 in which the application completes the drag and drop action. That is, the application allows the player card that is dragged to be dropped into a selected location with respect to the depth chart. Once the drag and drop action is completed, the application generates the depth chart based on the updated data and the completed drag and drop action in a step 1261. After the application generates the depth chart, the application renders the depth chart for viewing on the display screen in step 1205.

Returning to step 1245, if it is determined that data has not been updated, then in a step 1273, the application completes the drag and drop action. Once the drag and drop action is completed, the application generates the depth chart based on the completed drag and drop action in a step 1277. The application then renders the depth chart for viewing on the display screen in step 1205.

Returning to step 1241 and the determination of whether a drag action is valid, if the determination is that the drag action is not valid, then process flow proceeds to a step 1265 in which the application generates and provides a notification of an invalid drag action. For example, the application may cause a notification to be rendered on the display screen of a user endpoint which effectively informs a user that a player card may not be dragged, or may not be dragged and dropped into a zone associated with a particular formation or position. Once the notification is generated and provided, the application effectively voids the drag and drop action in a step 1269, and process flow returns to step 1205 in which the application continues to render the depth chart for viewing on the display screen,

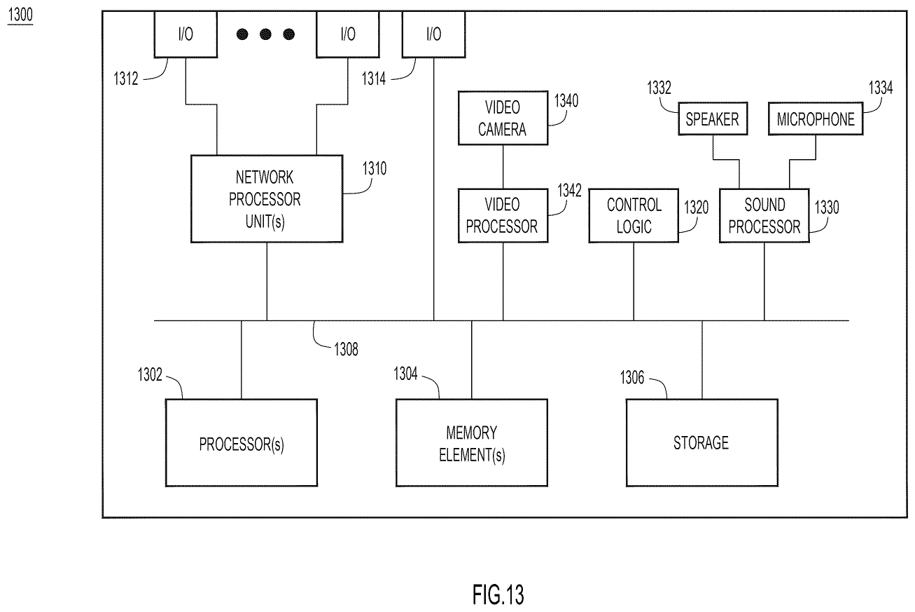

Referring next to FIG. 13, a computing system or device which is suitable for performing functions associated with operations discussed with respect to the figures above will be described in accordance with an embodiment. In some embodiments, an apparatus or computing device 1300 may be configured as any entity or entities as discussed for the techniques depicted in connection with the figures described above in order to perform operations of the various techniques discussed herein.

Computing device 1300 may be any apparatus that may include one or more processor(s) 1302 one or more memory element(s) 1304, storage 1306, a bus 1308, one or more network processor unit(s) 1310 interconnected with one or more network input/output (I/O) interface(s) 1312, one or more input/output (I/O) interface(s) 1314, and control logic 1320. In some embodiments, instructions associated with logic for computing device 1300 may overlap in any suitable manner, and are not limited to the specific allocation of instructions and/or operations described herein.

Processor(s) 1302 may include at least one hardware processor configured to execute various tasks, operations, and/or functions for computing device 1300 as described herein according to logic, software, and/or instructions configured for computing device 1300. Processor(s) 1302, as for example one or more hardware processors, may execute substantially any type of instructions associated with data to achieve the operations detailed herein. By way of example, processor(s) 1302 may transform an element or an article such as data or information from one state or thing to another state or thing. Any of potential processing elements, microprocessors, digital signal processor, baseband signal processor, modem, PHY, controllers, systems, managers, logic, and/or machines described herein may be construed as being encompassed within the broad term “processor.”

Memory element(s) 1304 and/or storage 1306 may be configured to store data, information, software, and/or instructions associated with computing device 1300, and/or logic configured for memory element(s) 1304 and/or storage 1306. By way of example, any logic described herein such as control logic 1320 may, in some embodiments, be stored for computing device 1300 using any combination of memory element(s) 1304 and/or storage 1306. It should be appreciated that storage 1306 may be consolidated with memory element(s) 1304, or vice versa, and/or may overlap or exist in any other suitable manner.

In one embodiment, bus 1308 may be configured as an interface that enables one or more elements of computing device 1300 to communicate in order to exchange information and/or data. Bus 1308 may be implemented with substantially any architecture designed for passing control, data and/or information between processors, memory elements or storage, peripheral devices, and/or any other hardware and/or software components that may be configured for computing device 1300. In at least one embodiment, bus 1308 may be implemented as a fast kernel-hosted interconnect, potentially using shared memory between processes, as for example logic, which may enable efficient communication paths between the processes. As shown, control logic 1320, a source processor 1330, and a video processor 1342 may be included in elements that communicate using bus 1308. Sound processor 1330 may be coupled to a speaker 1332 and a microphone 1334, while video processor 1342 may be coupled to a video camera 1340.

Network processor unit(s) 1310 may enable communication between computing device 1300 and other systems, entities, etc., via network I/O interface(s) 1312 which may be wired and/or wireless to facilitate operations discussed for various embodiments described herein. Network processor unit(s) 1310 may be configured as a combination of hardware and/or software, such as one or more Ethernet driver(s) and/or controller(s) or interface cards, optical driver(s) and/or controller(s) such as Fibre Channel, wireless receivers/transmitters/transceivers, baseband processor(s)/modem(s), and/or other similar network interface driver(s) and/or controller(s) now known or hereafter developed to enable communications between computing device 1300 and other systems, entities, etc. to facilitate operations for various embodiments described herein. In one embodiment, network I/O interface(s) 1312 may be configured as one or more Ethernet port(s), Fibre Channel ports, any other I/O port(s), and/or antenna(s)/antenna array(s) now known or hereafter developed. Thus, network processor unit(s) 1310 and/or network I/O interface(s) 1312 may include suitable interfaces for receiving, transmitting, and/or otherwise communicating data and/or information in a network environment.

I/O interface(s) 1314 may allow for input and output of data and/or information with other entities that may be connected to computing device 1300. For example, I/O interface(s) 1314 may provide a connection to external devices such as a keyboard, keypad, a touch screen, and/or any other suitable input and/or output device now known or hereafter developed. In some instances, external devices may also include, but are not limited to including, portable computer readable, non-transitory storage media such as database systems, thumb drives, portable optical or magnetic disks, and memory cards. External devices may also include a structure or mechanism arranged to display data to a user, such as, for example, a computer monitor, a display screen, or the like.

Control logic 1320 may include instructions that, when executed, cause processor(s) 1302 to perform operations, which may include, but are not limited to including, providing overall control operations of computing device; interacting with other entities, systems, etc. described herein; maintaining and/or interacting with stored data, information, parameters, etc. as for example memory element(s), storage, data structures, databases, tables, etc.; combinations thereof; and/or the like to facilitate various operations for embodiments described herein.

The programs described herein, as for example control logic 1320 may be identified based upon one or more applications for which the programs are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Although only a few embodiments have been described in this disclosure, it should be understood that the disclosure may be embodied in many other specific forms without departing from the spirit or the scope of the present disclosure. By way of example, while the use of the techniques in the disclosure have been described as being suitable for teams, the techniques are not limited to being suitable for teams such as sports teams. The techniques described above may be applied to any suitable group, squad, unit, cooperative unit, party, company, brigade, battalion, crew, organization, side, etc. In other words, a team may generally be a grouping of a plurality of individuals.

The view or configuration associated with a depth chart may vary. While a depth chart associated with a sports team may effectively be rendered as an overhead view of a playing field, a depth chart is not limited to being rendered as an overhead view of a playing field. In one embodiment, rather than present a depth chart or schema as an overhead view of a playing field, a depth chart or schema may instead be presented in a player view, or a view as seen from the point-of-view of a player on the playing field.

The components included in an analytics engine may vary. In one embodiment, as described above, an analytics engine may include a data normalization arrangement, a training/inference arrangement, and an “enrichment” or assessment arrangement. The data normalization arrangement may normalize data ingested from, or obtained from, data sources. The training/inference arrangement may determine metrics using ingested data, and may train any intelligence associated with the analytics engine. The “enrichment” arrangement may provide assessments or insights into analytics generated using data ingested from data sources. It should be appreciated, however, that an analytics engine is not limited to including a data normalization arrangement, a training/inference arrangement, and an “enrichment” arrangement.

The platform or system described above allows for intelligent position management for a team such as a sports team. The system also provides a formation intelligence engine that provide dynamic position morphing based on the selection of a particular formation. The system further provides real-time synchronization capabilities which supports real-time or live collaborative editing with multiple users, allows substantially instant synchronization across different view modes or levels, and supports optimistic UI updates with automatic rollback. A comprehensive audit system of the system provides change tracking with event sourcing, allows for historical state management with version control, and supports time-travel debugging and comparison capabilities.

In one embodiment, a formation-based auto-layout algorithm provides a substantially automatic layout system that adapts player positions based on selected formations, e.g., offensive and/or defensive formations.

A depth chart interaction flow, as discussed above with respect to FIG. 7A, may generally involve user interactions with respect to a depth chart. An overall user interaction flow may include, in some embodiments, engaging with predictive drop zones, multi-stage validations, real-time collaboration, and intelligent error handling. The user of predictive drop zones may involve a prediction of where a user intends to place a player, or move a player card associated with the player. Predictive drop zones include dynamic constraint visualization and/or an intelligent feedback system. For example, a drop zone that is predicted, as for example through artificial intelligence associated with an intelligent UI layer such as intelligent user UI layer 220 of FIG. 2, base on player attributes may be highlighted. Multi-stage validations include, but are not limited to including, a pre-drop validation that facilitates real-time or substantially immediate feedback, post-drop cascade updates, and/or formation integrity maintenance. Post-drop cascade updates may include automatically reordering the updates based on any suitable criterion. Real-time collaboration may involve conflict resolution for substantially simultaneous edits, live update animations for remote changes, and/or a substantially seamless multi-user experience. Intelligent error handling may include, but is not limited to including, generating and presenting contextual error messages with suggestions on how to mitigate errors, generating and presenting alternative placement recommendations for player cards, and obtaining and applying user patterns.

In some aspects, the techniques described herein relate to a method including: rendering a depth chart for a team for viewing on a display screen of a system, the team including personnel, the depth chart including at least one card, the at least one card include at least one parameter associated with the personnel, wherein the system enables a user to manipulate the depth chart; identifying a manipulation of the depth chart; determining whether data used to render the depth chart has been updated; updating the depth chart based on the manipulation, wherein when it is determined that the data has been updated, updating the depth chart further includes updating the depth chart based on the data that has been updated, and wherein updating the depth chart creates an updated depth chart; and rendering the updated depth chart for viewing on the display screen.

In some aspects, the techniques described herein relate to a method wherein the team is a sports team and the personnel includes at least one player on the sports team, the method further including: obtaining the data used to render the depth chart, wherein the data includes the at least one parameter, the at least one parameter being selected from a group including performance data for the at least one player, biometric data for the at least one player, financial data for the at least one player, and character data for the at least one player.

In some aspects, the techniques described herein relate to a method wherein the depth chart is rendered in a first view level and the manipulation is a view change request, wherein rendering the updated depth chart includes rendering the updated depth chart in a second view level.

In some aspects, the techniques described herein relate to a method wherein the manipulation is a drag action of an overall drag and drop action, the method further including: determining whether the drag action is valid; completing the overall drag and drop action when it is determined that the drag action is valid, wherein completing the overall drag and drop action includes moving the at least one card from a first position to a second position with respect to the depth chart; and voiding the overall drag and drop action when it is determined that the drag action is not valid.

In some aspects, the techniques described herein relate to a method wherein determining whether the drag action is valid includes: validating the second position in real-time; and confirming a formation integrity of the depth chart if the at least one card is moved to the second position.

In some aspects, the techniques described herein relate to a method wherein validating the second position includes validating the second position based on at least one selected from a group including formation rules, team requirements, and player eligibility.

In some aspects, the techniques described herein relate to a method further including: applying cascade updates after the at least one card is moved to the second position; logging a change event in response to the overall drag and drop action; and creating an audit entry associated with the overall drag and drop action.

In some aspects, the techniques described herein relate to a method further including: displaying a notification on the display screen when it is determined that the data used to render the depth chart has been updated; obtaining a confirmation of the notification; and updating the depth chart based on the manipulation after obtaining the confirmation of the notification.

In some aspects, the techniques described herein relate to a method wherein rendering the depth chart for the team for viewing on the display screen of the system includes rendering a heat map, wherein rendering the heat map includes highlighting a first area of the depth chart to indicate a relatively high amount of a particular criterion and highlighting a second area of the depth chart to indicate a relatively low amount of the particular criterion.

In some aspects, the techniques described herein relate to a method wherein the team is a sports team and the particular criterion is a spend level for the sports team.

In some aspects, the techniques described herein relate to a method further including: identifying a formation change in the depth chart; and reconfiguring the depth chart after the formation change is identified, wherein reconfiguring the depth chart includes adjusting at least one position group based on at least one rule of the formation change, adjusting a position of the at least one card to maintain formation integrity, and validating positions in the depth chart against formation constraints.

In some aspects, the techniques described herein relate to a method wherein rendering the depth chart includes predictively highlighting at least one potential drop zone in the depth chart based on at least one selected from a group including player position eligibility, a formation requirement, a historical placement patterns, and a current roster composition for the team.

In some aspects, the techniques described herein relate to one or more non-transitory computer readable storage media encoded with instructions, that when executed by a processor, cause the processor to perform: rendering a depth chart for a team for viewing on a display screen of a system, the team including personnel, the depth chart including at least one card, the at least one card include at least one parameter associated with the personnel, wherein the system enables a user to manipulate the depth chart; identifying a manipulation of the depth chart; determining whether data used to render the depth chart has been updated; updating the depth chart based on the manipulation, wherein when it is determined that the data has been updated, updating the depth chart further includes updating the depth chart based on the data that has been updated, and wherein updating the depth chart creates an updated depth chart; and rendering the updated depth chart for viewing on the display screen.

In some aspects, the techniques described herein relate to one or more non-transitory computer readable storage media wherein the team is a sports team and the personnel includes at least one player on the sports team, and wherein the instructions, when executed by a processor, further cause the processor to perform: obtaining the data used to render the depth chart, wherein the data includes the at least one parameter, the at least one parameter being selected from a group including performance data for the at least one player, biometric data for the at least one player, financial data for the at least one player, and character data for the at least one player.

In some aspects, the techniques described herein relate to one or more non-transitory computer readable storage media wherein the depth chart is rendered in a first view level and the manipulation is a view change request, and wherein rendering the updated depth chart includes rendering the updated depth chart in a second view level.

In some aspects, the techniques described herein relate to one or more non-transitory computer readable storage media wherein the manipulation is a drag action of an overall drag and drop action, and wherein the instructions, when executed by the processor, further cause the processor to perform: determining whether the drag action is valid; completing the overall drag and drop action when it is determined that the drag action is valid, wherein completing the overall drag and drop action includes moving the at least one card from a first position to a second position with respect to the depth chart; and voiding the overall drag and drop action when it is determined that the drag action is not valid.

In some aspects, the techniques described herein relate to one or more non-transitory computer readable storage media wherein determining whether the drag action is valid includes: validating the second position in real-time; and confirming a formation integrity of the depth chart if the at least one card is moved to the second position.

In some aspects, the techniques described herein relate to one or more non-transitory computer readable storage media wherein validating the second position includes validating the second position based on at least one selected from a group including formation rules, team requirements, and player eligibility.

In some aspects, the techniques described herein relate to one or more non-transitory computer readable storage media wherein the instructions, when executed by the processor, further cause the processor to perform: applying cascade updates after the at least one card is moved to the second position; logging a change event in response to the overall drag and drop action; and creating an audit entry associated with the overall drag and drop action.

In some aspects, the techniques described herein relate to one or more non-transitory computer readable storage media wherein the instructions, when executed by the processor, further cause the processor to perform: displaying a notification on the display screen when it is determined that the data used to render the depth chart has been updated; obtaining a confirmation of the notification; and updating the depth chart based on the manipulation after obtaining the confirmation of the notification.

In some aspects, the techniques described herein relate to one or more non-transitory computer readable storage media wherein rendering the depth chart for the team for viewing on the display screen of the system includes rendering a heat map, wherein rendering the heat map includes highlighting a first area of the depth chart to indicate a relatively high amount of a particular criterion and highlighting a second area of the depth chart to indicate a relatively low amount of the particular criterion.

In some aspects, the techniques described herein relate to one or more non-transitory computer readable storage media wherein the team is a sports team and the particular criterion is a spend level for the sports team.

In some aspects, the techniques described herein relate to a system including: an analytics engine, the analytics engine configured to obtain data from at least one data source, the data including information about personnel on a team, the analytics engine further being arranged to process the data to obtain a plurality of analytics results associated with the team; and an application engine including an intelligent user interface (UI) layer, a position intelligence engine, a data persistence layer, and a state synchronization engine, wherein the application engine is configured to process the analytics results to generate a depth chart for display on a display screen of an endpoint and to render the depth chart in a first view on the display screen, the application engine further being configured to generate an updated depth chart based at least on a manipulation of the depth chart at the endpoint and to render the updated depth chart in a second view on the display screen.

In some aspects, the techniques described herein relate to a system wherein the team is a sports team and the personnel includes at least one player, and wherein the depth chart includes a player card associated with the at least one player, the player card arranged to indicate at least a position of the at least one player.

In some aspects, the techniques described herein relate to a system wherein the intelligent UI layer is configured to determine when the manipulation is a drag action of an overall drag and drop action to drag the player card from a first location, and wherein the intelligent UI layer is further configured to predict a second location to which the player card is to be dragged.

In some aspects, the techniques described herein relate to a system wherein the position intelligence engine is configured to determine whether an overall drag and drop action to drag a player card from a first location to a second location is valid.

In some aspects, the techniques described herein relate to a system wherein the data persistence layer is configured to maintain an audit trail that includes the overall drag and drop action.

In some aspects, the techniques described herein relate to a system wherein the state synchronization engine is configured to resolve conflicts associated with the updated depth chart.

In some aspects, the techniques described herein relate to a system wherein the state synchronization engine includes: a Zustand-based state management system with middleware, connections for real-time updates, a conflict resolution engine that utilizes a timestamp, and an event sourcing system arranged to achieve state reconstruction.

In some aspects, the techniques described herein relate to a system wherein the position intelligence engine includes: a formation constraint matrix configured to store position-specific rules, a validation pipeline with pre-drop and post-drop validation stages, a cascade update engine for maintaining formation integrity, and a predictive placement algorithm that utilizes historical patterns.

In some aspects, the techniques described herein relate to a method for dynamic team visualization, the method including: rendering a visualization of a team on a first display device, the visualization including one or more displayed elements, wherein the visualization is based on data associated with personnel of the team; identifying a user interaction with the one or more displayed elements; validating the user interaction, wherein validating the user interaction includes applying one or more formation-based constraints; determining whether the data has changed; updating the visualization based on the user interaction to generate an updated visualization when the user interaction is validated, wherein updating the visualization includes applying any changes to the data when it is determined that the data has changed; and synchronizing the updated visualization across a plurality of display devices including the first display device.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
rendering a depth chart for a team for viewing on a display screen of a system, the team including personnel, the depth chart including at least one card, the at least one card include at least one parameter associated with the personnel, wherein the system enables a user to manipulate the depth chart;
identifying a manipulation of the depth chart;
determining whether data used to render the depth chart has been updated;
updating the depth chart based on the manipulation, wherein when it is determined that the data has been updated, updating the depth chart further includes updating the depth chart based on the data that has been updated, and wherein updating the depth chart creates an updated depth chart; and
rendering the updated depth chart for viewing on the display screen.

2. The method of claim 1 wherein the team is a sports team and the personnel includes at least one player on the sports team, the method further including:
obtaining the data used to render the depth chart, wherein the data includes the at least one parameter, the at least one parameter being selected from a group including performance data for the at least one player, biometric data for the at least one player, financial data for the at least one player, and character data for the at least one player.

3. The method of claim 1 wherein the depth chart is rendered in a first view level and the manipulation is a view change request, wherein rendering the updated depth chart includes rendering the updated depth chart in a second view level.

4. The method of claim 1 wherein the manipulation is a drag action of an overall drag and drop action, the method further including:
determining whether the drag action is valid;
completing the overall drag and drop action when it is determined that the drag action is valid, wherein completing the overall drag and drop action includes moving the at least one card from a first position to a second position with respect to the depth chart; and
voiding the overall drag and drop action when it is determined that the drag action is not valid.

5. The method of claim 4 wherein determining whether the drag action is valid includes:
validating the second position in real-time; and
confirming a formation integrity of the depth chart if the at least one card is moved to the second position.

6. The method of claim 5 wherein validating the second position includes validating the second position based on at least one selected from a group including formation rules, team requirements, and player eligibility.

7. The method of claim 5 further including:
applying cascade updates after the at least one card is moved to the second position;
logging a change event in response to the overall drag and drop action; and
creating an audit entry associated with the overall drag and drop action.

8. The method of claim 1 further including:
displaying a notification on the display screen when it is determined that the data used to render the depth chart has been updated;
obtaining a confirmation of the notification; and
updating the depth chart based on the manipulation after obtaining the confirmation of the notification.

9. The method of claim 1 wherein rendering the depth chart for the team for viewing on the display screen of the system includes rendering a heat map, wherein rendering the heat map includes highlighting a first area of the depth chart to indicate a relatively high amount of a particular criterion and highlighting a second area of the depth chart to indicate a relatively low amount of the particular criterion.

10. The method of claim 9 wherein the team is a sports team and the particular criterion is a spend level for the sports team.

11. The method of claim 1 further including:
identifying a formation change in the depth chart; and
reconfiguring the depth chart after the formation change is identified, wherein reconfiguring the depth chart includes adjusting at least one position group based on at least one rule of the formation change, adjusting a position of the at least one card to maintain formation integrity, and validating positions in the depth chart against formation constraints.

12. The method of claim 1 wherein rendering the depth chart includes predictively highlighting at least one potential drop zone in the depth chart based on at least one selected from a group including player position eligibility, a formation requirement, a historical placement patterns, and a current roster composition for the team.

13. One or more non-transitory computer readable storage media encoded with instructions, that when executed by a processor, cause the processor to perform:
rendering a depth chart for a team for viewing on a display screen of a system, the team including personnel, the depth chart including at least one card, the at least one card include at least one parameter associated with the personnel, wherein the system enables a user to manipulate the depth chart;
identifying a manipulation of the depth chart;
determining whether data used to render the depth chart has been updated;
updating the depth chart based on the manipulation, wherein when it is determined that the data has been updated, updating the depth chart further includes updating the depth chart based on the data that has been updated, and wherein updating the depth chart creates an updated depth chart; and
rendering the updated depth chart for viewing on the display screen.

14. The one or more non-transitory computer readable storage media of claim 13 wherein the team is a sports team and the personnel includes at least one player on the sports team, and wherein the instructions, when executed by a processor, further cause the processor to perform:
obtaining the data used to render the depth chart, wherein the data includes the at least one parameter, the at least one parameter being selected from a group including performance data for the at least one player, biometric data for the at least one player, financial data for the at least one player, and character data for the at least one player.

15. The one or more non-transitory computer readable storage media of claim 13 wherein the depth chart is rendered in a first view level and the manipulation is a view change request, and wherein rendering the updated depth chart includes rendering the updated depth chart in a second view level.

16. The one or more non-transitory computer readable storage media of claim 13 wherein the manipulation is a drag action of an overall drag and drop action, and wherein the instructions, when executed by the processor, further cause the processor to perform:
determining whether the drag action is valid;
completing the overall drag and drop action when it is determined that the drag action is valid, wherein completing the overall drag and drop action includes moving the at least one card from a first position to a second position with respect to the depth chart; and
voiding the overall drag and drop action when it is determined that the drag action is not valid.

17. The one or more non-transitory computer readable storage media of claim 16 wherein determining whether the drag action is valid includes:
validating the second position in real-time; and
confirming a formation integrity of the depth chart if the at least one card is moved to the second position.

18. The one or more non-transitory computer readable storage media of claim 17 wherein validating the second position includes validating the second position based on at least one selected from a group including formation rules, team requirements, and player eligibility.

19. The one or more non-transitory computer readable storage media of claim 17 wherein the instructions, when executed by the processor, further cause the processor to perform:
applying cascade updates after the at least one card is moved to the second position;
logging a change event in response to the overall drag and drop action; and
creating an audit entry associated with the overall drag and drop action.

20. The one or more non-transitory computer readable storage media of claim 13 wherein the instructions, when executed by the processor, further cause the processor to perform:
displaying a notification on the display screen when it is determined that the data used to render the depth chart has been updated;
obtaining a confirmation of the notification; and
updating the depth chart based on the manipulation after obtaining the confirmation of the notification.

21. The one or more non-transitory computer readable storage media of claim 13 wherein rendering the depth chart for the team for viewing on the display screen of the system includes rendering a heat map, wherein rendering the heat map includes highlighting a first area of the depth chart to indicate a relatively high amount of a particular criterion and highlighting a second area of the depth chart to indicate a relatively low amount of the particular criterion.

22. The one or more non-transitory computer readable storage media of claim 21 wherein the team is a sports team and the particular criterion is a spend level for the sports team.

23. A system comprising:
an analytics engine, the analytics engine configured to obtain data from at least one data source, the data including information about personnel on a team, the analytics engine further being arranged to process the data to obtain a plurality of analytics results associated with the team; and
an application engine including an intelligent user interface (UI) layer, a position intelligence engine, a data persistence layer, and a state synchronization engine, wherein the application engine is configured to process the analytics results to generate a depth chart for display on a display screen of an endpoint and to render the depth chart in a first view on the display screen, the application engine further being configured to generate an updated depth chart based at least on a manipulation of the depth chart at the endpoint and to render the updated depth chart in a second view on the display screen.

24. The system of claim 23 wherein the team is a sports team and the personnel includes at least one player, and wherein the depth chart includes a player card associated with the at least one player, the player card arranged to indicate at least a position of the at least one player.

25. The system of claim 24 wherein the intelligent UI layer is configured to determine when the manipulation is a drag action of an overall drag and drop action to drag the player card from a first location, and wherein the intelligent UI layer is further configured to predict a second location to which the player card is to be dragged.

26. The system of claim 23 wherein the position intelligence engine is configured to determine whether an overall drag and drop action to drag a player card from a first location to a second location is valid.

27. The system of claim 26 wherein the data persistence layer is configured to maintain an audit trail that includes the overall drag and drop action.

28. The system of claim 23 wherein the state synchronization engine is configured to resolve conflicts associated with the updated depth chart.

29. The system of claim 23 wherein the state synchronization engine includes:
a Zustand-based state management system with middleware, connections for real-time updates, a conflict resolution engine that utilizes a timestamp, and an event sourcing system arranged to achieve state reconstruction.

30. The system of claim 23 wherein the position intelligence engine includes:
a formation constraint matrix configured to store position-specific rules, a validation pipeline with pre-drop and post-drop validation stages, a cascade update engine for maintaining formation integrity, and a predictive placement algorithm that utilizes historical patterns.

31. A method for dynamic team visualization, the method comprising:
rendering a visualization of a team on a first display device, the visualization including one or more displayed elements, wherein the visualization is based on data associated with personnel of the team;
identifying a user interaction with the one or more displayed elements;
validating the user interaction, wherein validating the user interaction includes applying one or more formation-based constraints;
determining whether the data has changed;
updating the visualization based on the user interaction to generate an updated visualization when the user interaction is validated, wherein updating the visualization includes applying any changes to the data when it is determined that the data has changed; and
synchronizing the updated visualization across a plurality of display devices including the first display device.
